(19) United States
(12) Patent Application Publication
(10) Pub. No.: US 2026/0228486 A1
(43) Pub. Date: Aug. 6, 2026

(54) SEQUENCE PROCESSING USING ATTENTION AND SUB-SAMPLING

(71) Applicant: GDM Holding LLC, Mountain View, CA (US)

(72) Inventors: Feryal Behbahani, London (GB); Edward Fauchon Hughes, Hereford (GB); Kate Alexandra Baumli, London (GB); Jakob Elias Bauer, London (GB); Avishkar Ajay Bhoopchand, London (GB); Yannick Schroecker, London (GB); Karol Gregor, London (GB)

(21) Appl. No.: 19/149,185

(22) PCT Filed: Jan. 19, 2024
(86) PCT No.: PCT/EP2024/051262

§ 371 Date: Jul. 18, 2025

(30) Foreign Application Priority Data
Jan. 19, 2023 (GB) 2300845.1

(51) Int. Cl. G06N 3/044

(52) U.S. Cl. CPC G06N 3/044

(57) ABSTRACT

A computer-implemented method that comprises obtaining an input sequence of network inputs, processing each network input in the input sequence using a recurrent neural network to generate a sequence of recurrent outputs that includes a respective recurrent output for each network input in the input sequence, generating a sub-sampled sequence that includes a proper subset of the respective recurrent outputs, and processing the sub-sampled sequence using a self-attention neural network to generate a network output for the input sequence. The self-attention neural network comprises a self-attention subnetwork configured to apply self-attention over the sub-sampled sequence to generate a respective updated output for each recurrent output in the sub-sampled sequence and an output neural network configured to process one or more of the updated outputs to generate the network output for the input sequence.

### BACKGROUND

This specification relates to processing data using machine learning models.

Self-attentive neural networks such as the Transformer (Vaswani et al.) have been shown to achieve impressive results on sequence modeling tasks, some examples including machine translation, image processing (which can represented as sequence modeling), audio signal processing, and in general processing data from real-world sensors. However one drawback of such neural networks is the computation needed to process long data sequences and hence, e.g. capture longer-term dependencies in the data. The Transformer model is described in Vaswani et al., Attention Is All You Need, 31st Conference on Neural Information Processing Systems (NIPS 2017), Long Beach, CA, USA, available at https://papers.nips.cc/paper/7181-attention-is-all-you-need.pdf.

### SUMMARY

This specification describes systems that include a self-attention neural network and that facilitate capture of longer-term dependencies in processed data.

In one aspect there is described a method performed by one or more computers, and a corresponding system. The method obtains an input sequence of network inputs and processes each network input in the input sequence using a recurrent neural network to generate a sequence of recurrent outputs that includes a respective recurrent output for each network input in the input sequence.

The method generates a sub-sampled sequence that includes a proper subset (i.e. less than all) of the respective recurrent outputs. The sub-sampled sequence is processed using a self-attention neural network to generate a network output for the input sequence.

In implementations the self-attention neural network comprises a self-attention subnetwork configured to apply self-attention over the sub-sampled sequence to generate a respective updated output for each recurrent output in the sub-sampled sequence, and in general also an output neural network configured to process one or more of the updated outputs to generate the network output for the input sequence.

Each network input in the input sequence may correspond to a respective time step. Each network input may represent an observation characterizing a state of an environment at the corresponding time step. The network output for the input sequence may comprise a policy output that defines an action to be performed by an agent interacting with the environment in response to the observation represented by a last network input in the input sequence. The network output may further comprise a value output that represents an expected return received starting from the respective time step corresponding to the last network input in the input sequence. Each network input may comprise an embedding of the observation characterizing the state of an environment at the corresponding time step generated by an embedding neural network. The output neural network may comprise a second recurrent neural network configured to generate policy outputs for time steps between sub-sampled time steps corresponding to the sub-sampled sequence.

Network inputs in the input sequence may correspond to a respective time step in an audio signal and represents an audio sample at the corresponding time step in the audio signal. Network inputs in the input sequence may represent a respective image in a sequence of images.

The self-attention subnetwork may include one or more self-attention layer blocks that each apply self-attention to update the sub-sampled sequence. At least one of self-attention layer blocks apply self-attention with segment-level recurrence. The self-attention subnetwork may be configured to apply normalization to an output of one or more of the self-attention layer blocks. Each self-attention layer block may comprise a self-attention layer that applies self-attention to update the sub-sampled sequence and a gated feedforward neural network that is configured to further update each output in the updated sub-sampled sequence.

Processing each network input in the input sequence using a recurrent neural network to generate a sequence of recurrent outputs that includes a respective recurrent output for each network input in the input sequence may comprise, prior to processing a first network input in the input sequence, initializing an internal state of the recurrent neural network. The method may include, for each network input in the input sequence, processing the network input using the recurrent neural network in accordance with the internal state to update the internal state and generate the respective recurrent output for the network input. The recurrent neural network may include one or more recurrent layers. The internal state may include a respective layer internal state for each of the one or more recurrent layers. The respective recurrent output for the network input may be the updated the layer internal state of a last recurrent layer after processing the network input.

The recurrent neural network may be a gated recurrent unit (GRU).

Generating a sub-sampled sequence that includes a proper subset of the respective recurrent outputs may comprise selecting for inclusion in the sub-sampled sequence only every k-th recurrent output in the sequence of recurrent outputs, wherein k is an integer that is greater than one. k may be, for example, between 4 and 10, inclusive. The neural network may have been trained to perform a number of trials per training example in a training set that is commensurate with k. For example, the number of trials per training example may be between 4 and 10 times more than a baseline number of trials. The baseline may be, for example, between 6 and 12.

Each network input in the input sequence may comprise an embedding, for example of multimodal data. Throughout this specification, an “embedding” of an entity (e.g., an observation of an environment) can refer to a representation of the entity as an ordered collection of numerical values, e.g., a vector or matrix of numerical values. An embedding of an entity can be generated, e.g., as the output of a neural network that processes data characterizing the entity, or as a result of some other encoding process.”

Optionally, in any of the above implementations, the observation at any given time step may include data from a previous time step that may be beneficial in characterizing the environment, e.g., the action performed at the previous time step, the reward received at the previous time step, or both.

The techniques described herein may provide one or more of the following advantages.

Memory enables the neural network system to store and recall information learned or experienced in the past, and therefore allows a neural network system to adapt over multiple tasks episodes (i.e. performance of a single task multiple times). In order for a neural network system to effectively adapt, it is beneficial for the memory of the neural network system to allow recall of information from both the recent and more distant past. While slow gradient-based updates are able to capture the latter, they are often not fast enough to capture the former, i.e. they cannot provide fast adaptation. Prior art methods have relied recurrent neural networks (RNNs) to provide a mechanism for fast adaptation to recent information. However, RNNs may not be capable of adaptation in challenging tasks, such as in completing tasks in a partially-observable embodied 3D task space. By generating the sub-sampled sequence and processing it using the self-attention neural network, the present techniques enables fast adaptation on challenging tasks.

### BRIEF DESCRIPTION OF FIGURES

Embodiments of the invention will now be described, by way of example, with reference to the accompanying drawings, in which:

FIG. 1 is a flow diagram of an example process for processing an input to generate a network output;

FIG. 2 shows an example neural network system for processing an input sequence to generate a network output; and

FIG. 3 is a chart showing the performance of techniques described herein in comparison to previous baselines.

### DETAILED DESCRIPTION

Memory properties of some neural network systems, such as recurrent neural networks (RNNs) and long short-term memory (LSTM) networks allow neural networks to keep track of dependencies in input sequences. When processing an input in a sequence, a neural network with memory therefore uses both the current input and previous inputs.

For example, where a neural network is trained to produce a network output comprising a policy output that defines an action to be performed by an agent interacting with an environment to complete a task, it would be beneficial for the trained neural network to learn from previous interactions with the environment. Preferably, memory would allow recall of information from both the recent (fast adaptation) and more distant past (slow adaptation). While slow gradient-based updates are able to capture the latter, they are often not fast enough to capture the former. Further, RNNs as memory may not provide for adequate fast adaptation in challenging tasks, for example 3D task spaces

More generally, increasing the effective memory of a neural network system often provides a beneficial increase in the performance of the neural network. However, increasing memory has generally required an increase in computational resources. For example, to increase memory, it has been necessary to increase the number of parameters of the neural network, requiring both additional compute and memory. There is below techniques concerned with increasing the effective memory of a neural network without requiring a commensurate increase in physical computational cost and with only a limited effect on performance.

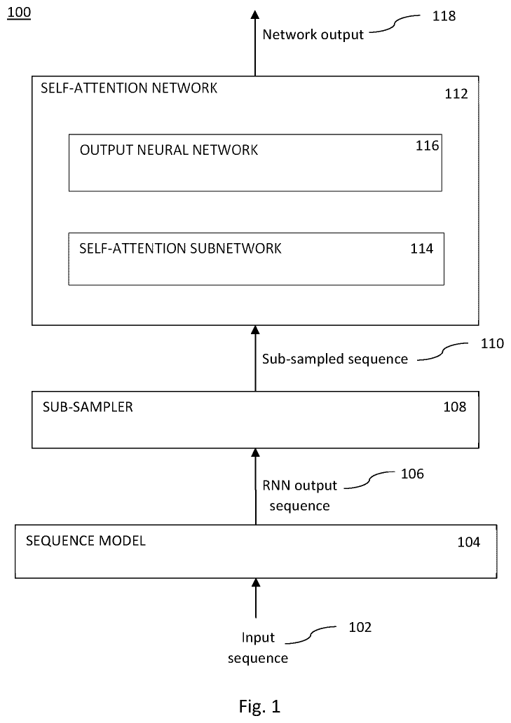

FIG. 1 depicts a neural network system 100 that receives an input sequence 102 comprising a sequence of network inputs. The network inputs in the input sequence 102 may be obtained in parallel or sequentially, e.g. a streaming fashion. In this latter case the entire sequence is not received and processed at the same time and instead each time a new input is received the relevant sequences can be updated by processing the new input using the recurrent neural network (with an internal state of the recurrent neural network that is the current internal state of the recurrent neural network). For example, the input sequence 102 may comprise network inputs representing an image or video in a sequential format. In this case, the input network inputs of the input sequence 102 may be received in parallel. In another example, the input sequence 102 may comprise network inputs representing respective observations received at sequential time steps, such as observations characterizing a state of an environment at the corresponding time step. Each network input may be an embedding generated by an embedding neural network (not shown). Examples of network inputs are provided below, but it will be appreciated that the embeddings may be embeddings of any network inputs, such as image data, video data, sound data, textual data, and sensor data. The embeddings may be embeddings of multi-modal data, i.e. data including multiple modes or types.

The input sequence is provided as input to a first sequence model 104 that is trained to encode the input sequence 102. In FIG. 1, the first sequence model 104 is an RNN and provides an RNN output sequence 106. The RNN output sequence 106 comprises a respective recurrent output for each of the network inputs in the input sequence 102. The first sequence model 104 may be a gated recurrent unit (GRU) or a long short-term memory (LSTM) network. The RNN output sequence 106 is processed by a sub-sampler 108 which is configured to generate a sub-sampled sequence 110 that includes a proper subset of the recurrent outputs in the RNN output sequence 106. In one example, the sub-sampler 108 may sample the recurrent outputs uniformly from the RNN output sequence 106. For example, the sub-sampler may select for inclusion in the sub-sampled sequence 110 only every k-th recurrent output where k is an integer greater than one. For example, the sub-sampled sequence 110 may include every 2^{nd} recurrent output, every 3rd recurrent output, every 4^{th} recurrent output, etc. In another example, the sub-sampled output sequence may not sample the recurrent outputs uniformly.

The sub-sampled sequence 110 is provided as input to a self-attention neural network 112 that is trained to generate a network output 118 for the input sequence 102. The self-attention neural network 112 comprises a self-attention subnetwork 114 and an output neural network 116. The self-attention subnetwork 114 is configured to apply self-attention over the sub-sampled sequence 110 to generate a respective updated output for each recurrent output in the sub-sampled sequence 110.

In general a self-attention operation can be one that applies an attention mechanism to elements of an embedding to update each element of the embedding. There are many different attention mechanisms that may be used. For example with a query-key-value (QKV) self-attention operation an input embedding is used to determine a query vector and a set of key-value vector pairs, and the updated embedding comprises a weighted sum of the values, weighted by a similarity function of the query to each respective key. A transformer network can be a neural network characterized by having a succession of self-attention neural network layers.

The self-attention subnetwork may comprise a Transformer neural network. In some implementations the self-attention subnetwork includes one or more self-attention layer blocks that each apply self-attention to update the sub-sampled sequence. A block is generally a group of one or more neural network layers in a neural network. In some implementations at least one of self-attention layer blocks applies self-attention with segment-level recurrence. For example the self-attention subnetwork may be configured to process fixed-length segments of input embeddings, and the representations computed for the previous segment may be fixed and cached to be reused as an extended context when the model processes a next, new segment.

The output neural network 116 is configured to process one or more of the updated outputs to generate the network output for input sequence 102. The output neural network 116 may comprise a second recurrent neural network configured to generate policy outputs for time steps between sub-sampled time steps corresponding to the sub-sampled sequence 110. That is, the output neural network 116 may, in effect, interpolate between time steps of the sub-sampled sequence 110. Whilst it may appear counter-intuitive to sub-sample and then re-introduce samples in between, this can have a similar effect to increasing the available memory. This is especially the case for real-world data that can often be highly temporally correlated over short time scales. The output neural network 116 may comprise, for example, a long short-term memory block. It will be appreciated that the self-attention neural network 112 may comprise other components, such as other neural network blocks, not shown in FIG. 1. For example, the output of the self-attention subnetwork 114 may be processed to generate an input to the output neural network 116. By way of example, the output of the self-attention subnetwork 114 may be passed to one or more neural networks.

In an example, the output neural network 116 may be unrolled for a number steps equal to k. That is, where the sub-sampler generates the sub-sampled sequence based on every k-th recurrent output, the output neural network may be unrolled for k steps starting from its initial state embedding.

The self-attention neural network 112 may comprise one or more RNNs with attention. For example, the self-attention neural network model may comprise an RNN with a multi-head attention module. Alternatively, the self-attention neural network may use neural networks with a Transformer architecture (Vaswani et al. 2017). In tests, a Transformer based architecture has been found to score more highly on tasks to generate an action of performance by an agent in a simulated environment, in comparison to an architecture based on RNN with attention. On the same tests, both RNN with attention and a Transformer-based architecture were found to significantly outperform an RNN without attention. The results of these tests are shown in FIG. 4 in which the x-axis shows a number of attempts, or trials, the agent completed for a given task. In some examples, the self-attention neural network may be a Transformer-XL architecture as described in the paper arXiv:1901.02860, Dai et al., 2019.

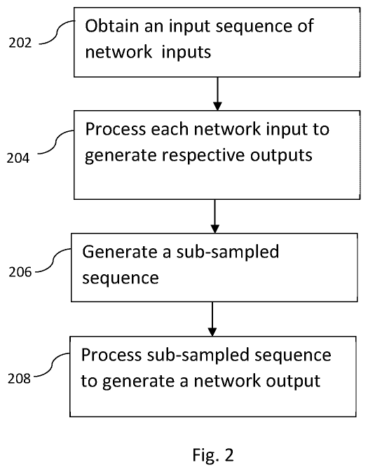

FIG. 2 is a flowchart showing an example method that may be used to increase the effective memory. At step 202, an input sequence of network inputs is obtained. At step 204, each network input in the input sequence is processed using a recurrent neural network to generate a sequence of recurrent outputs that includes a respective recurrent output for each network input in the input sequence. At step 206, a sub-sampled sequence is generated, the sub-sampled sequence including a proper subset of the respective recurrent outputs. That is, not all of the recurrent outputs are present in the sub-sampled sequence. At step 208, the sub-sampled sequence is processed using a self-attention neural network to generate a network output for the input sequence. The self-attention neural network comprises a self-attention subnetwork configured to apply self-attention over the sub-sampled sequence to generate a respective updated output for each recurrent output in the sub-sampled sequence. The self-attention neural network further comprises an output neural network, configured to process one or more of the updated outputs to generate the network output for the input sequence. A number of examples of possible tasks, network inputs and network outputs are set out in detail below. However, it will be appreciated that the techniques described herein are applicable to any task in which it is desired to increase the effective memory of an attention-based neural network without a corresponding increase in the computational requirements.

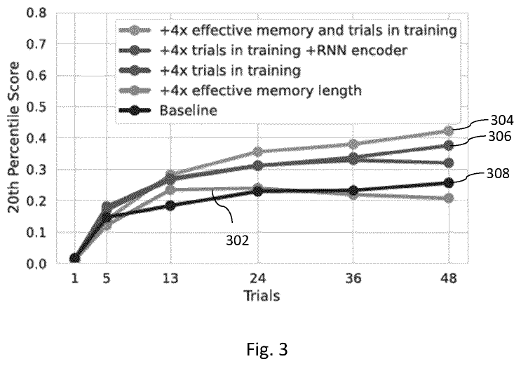

FIG. 3 shows the impact of increasing the effective memory of the neural network system. In this example, from plot 302, it can be seen that in tests, increasing the effective memory of the neural network system by a factor of four using the techniques described herein improved the performance (the 20^{th} percentile score) of a trained neural network system (in this example an agent configured to perform tasks in a virtual environment) that could perform up to 24 trials of any one task. It can be seen in FIG. 3 that the performance improvement seen by increasing the effective memory decreased beyond execution of 24 trials. However, as seen from plot 304, where additional trials were provided during training and the effective memory was increased, the effect of increasing the effective memory using the present techniques was to improve performance (above a baseline shown by plot 308) of the agent when performing at least up to 48 trials. As can be seen in FIG. 3, increasing the effective memory be a factor of four and increasing the number of trials during training by a factor of four provides an increase in the 20^{th} percentile score, up to at least 48 trials and provides a greater improvement than increasing only the number of trials during training (plot 306).

In some example implementations, therefore, there is a method of training a neural network system, the neural network system comprising a sequence model configured to process each network input in an input sequence to generate a sequence of recurrent outputs that includes a respective output for each network input in the input sequence. The neural network system further comprises a sub-sampler configured to generate a sub-sampled sequence that includes a proper subset of the respective recurrent outputs and a self-attention neural network configured to generate a network output for the input sequence. The self-attention neural network system comprises a self-attention subnetwork configured to apply self-attention over the sub-sampled sequence to generate a respective updated output for each recurrent output in the sub-sampled sequence, and an output neural network configured to process one or more of the updated outputs to generate the network output for the input sequence. In this way, as described above, the neural network system is configured to provide a similar effect to increasing the effective memory of the neural network system, without a commensurate increase in computational requirements. The method of training comprises training the neural network system on an increased number of training trials per task compared to a baseline. In some examples, the neural network system is configured to increase the effective memory by a particular factor and the number of trials per training task is increased over the baseline by at least the same factor. To provide a concrete example, a baseline training regime may comprise training a neural network system on between 1 and 6 trials per training task. The sub-sampler may be configured to generate a sub-sampled sequence that includes only a quarter of the network inputs enabling the self-attention neural network to attend over 4 times as many trials without additional computation. The training method may comprise providing between 1 and 24 training trials per task, i.e. up to a factor of 4 increase over the baseline training regime.

As described above, in some implementations each network input in the input sequence corresponds to a respective time step and represents an observation characterizing a state of an environment at the corresponding time step. The network output for the input sequence may comprise a policy output that defines an action to be performed by an agent interacting with the environment in response to the observation represented by a last network input in the input sequence. The method may include controlling the agent to perform the action, e.g. by outputting an appropriate agent control signal. In some examples, the agent may be a real-world agent, such as a mechanical, or electrical agent.

As some examples the policy output may comprise a probability distribution over a set of possible actions, or a Q value that is an estimate of a long-term time-discounted reward that would be received if the agent performs a particular action in response to the observation. Or the policy output may identify the action to be performed or parameterize a distribution from or using which an action to be performed is chosen or sampled, e.g. by defining the mean and variance of a torque to be applied to each of multiple movable components of a robot.

In some implementations, although the self-attention subnetwork processes the sub-sampled sequence the policy output can be generated for each time step. For example the output neural network can comprise a second recurrent neural network that is configured to provide the policy output for each (action) time step, e.g. by generating two or more policy outputs for every k-th recurrent output (where k>1).

That is, the output neural network can comprise a second recurrent neural network configured to generate policy outputs for time steps between sub-sampled time steps corresponding to the sub-sampled sequence, in effect to interpolate between time steps of the sub-sampled sequence. Whilst it may appear counter-intuitive to sub-sample and then re-introduce samples in between, this can have a similar effect to increasing the available memory. This is especially the case for real-world data that can often be highly temporally correlated over short time scales.

More generally the output neural network can comprise a second recurrent neural network that is configured to provide a network output for each network input in the input sequence, e.g. by generating two or more network outputs for every k-th recurrent output (where k>1).

In some implementations the system can be used to generate, from the input sequence, a network output that comprises an output sequence.

For example the input sequence and output sequence may each comprise a sequence of tokens.

For example in some implementations the input tokens and the output tokens each represent words, wordpieces or characters in a natural language. A wordpiece may be a sub-word (part of a word), and may be an individual letter or character. As used here, “characters” includes Chinese and other similar characters, as well as logograms, syllabograms and the like.

Some of these implementations may be used for natural language tasks such as providing a natural language response to a natural language input, e.g. for question answering, or for text completion. In some implementations the input sequence may represent text in a natural language and the output sequence may represent text in the same natural language, e.g. a longer item of text. For example in some implementations the input sequence may represent text in a natural language and the output sequence may represent the same text with a missing portion of the text added or filled in. For example the output sequence may represent a predicted completion of text represented by the input sequence. Such an application may be used, e.g. to provide an auto-completion function e.g. for natural language-based search. In some implementations the input sequence may represent a text in a natural language e.g. posing a question or defining a topic, and the output sequence may represent a text in a natural language which is a response to the question or about the specified topic.

As another example the input sequence may represent a first item of text and the output sequence may represent a second, shorter item of text e.g. the second item of text may be a summary of a passage that is the first item of text. As another example the input sequence may represent a first item of text and the output sequence may represent a simplification of the first item of text. As another example the input sequence may represent a first item of text and the output sequence may represent an aspect of the first item of text e.g. it may represent an entailment task, a paraphrase task, a textual similarity task, a sentiment analysis task, a sentence completion task, a grammaticality task, a parsing task, e.g., constituency parsing, and in general any natural language understanding task that operates on a sequence of text in some natural language e.g. to generate an output that classifies or predicts some property of the text. For example some implementations may be used to identify a natural language of the first item of text, or of spoken words where the input is audio (as described below).

Some implementations may be used to perform neural machine translation. Thus in some implementations the input tokens represent words, wordpieces, or characters in a first natural language and the output tokens represent words, wordpieces or characters in a second, different natural language. That is, the input sequence may represent input text in the first language and the output sequence may represent a translation of the input text into the second language.

Some implementations may be used for automatic code generation. For example the input tokens may represent words, wordpieces or characters in a first natural language and the output tokens may represent instructions in a computer programming or markup language, or instructions for controlling an application program to perform a task e.g. build a data item such as an image or web page.

Some implementations may be used for speech recognition. In such applications the input sequence may represent spoken words and the output sequence may represent a conversion of the spoken words to a machine-written representation e.g. text. Then the input tokens may comprise tokens representing an audio data input including the spoken words e.g. characterizing a waveform of the audio in the time domain or in the time-frequency domain. The output tokens may represent words, wordpieces, characters, or graphemes of a machine-written, e.g. text, representation of the spoken input, that is representing a transcription of the spoken input.

Some implementations may be used for handwriting recognition. In such applications the input sequence may represent handwritten words, syllabograms or characters and the output sequence may represent a conversion of the input sequence to a machine-written representation e.g. text. Then the input tokens may comprise tokens representing portions of the handwriting and the output tokens may represent words, wordpieces, characters or graphemes of a machine-written, e.g. text, representation of the spoken input.

Some implementations may be used for text-to-speech conversion. In such applications the input sequence may represent text and the output sequence may represent a conversion of the text to spoken words. Then the input tokens may comprise tokens representing words or wordpieces or graphemes of the text and the output tokens may represent portions of audio data for generating speech corresponding to the text, e.g. tokens characterizing a portion of a waveform of the speech in the time domain or in the time-frequency domain, or phonemes.

In some implementations the input sequence and the output sequence represent different modalities of input. For example the input sequence may represent text in a natural language and the output sequence may represent an image or video corresponding to the text; or vice-versa. In general the tokens may represent image or video features and a sequence of such tokens may represent an image or video. There are many ways to represent an image (or video) using tokens. As one example an image (or video) may be represented as a sequence of regions of interest (RoIs) in the image, optionally including one or more tokens for global image features. For example an image may be encoded using a neural network to extract Rol features; optionally (but not essentially) a token may also include data, e.g. a position encoding, representing a position of the Rol in the image. As another example, the tokens may encode color or intensity values for pixels of an image. As another example, some image processing neural network systems e.g. autoregressive systems, naturally represent images as sequences of image features.

As another example, a transformer-based sequence-to-sequence neural network system as previously described may be used to process images instead of or as well as text (e.g. if trained on images instead of or as well as text).

Thus in some implementations at least one of the input sequence and the output sequence is a sequence representing an image or video, and the tokens represent the image or video. For example the input sequence may be a sequence of text, the input tokens may represent words, wordpieces, or characters and the output sequence may comprise output tokens representing an image or video e.g. described by the text, or providing a visual answer to a question posed by the text, or providing a visualization of a topic of the text. In another example the input sequence may comprise a sequence of input tokens representing an image or video, and the output tokens may represent words or wordpieces, or characters representing text e.g. for a description or characterization of the image or video, or providing an answer to a question posed visually by the image or video, or providing information on a topic of a topic of the image or video.

In some other implementations both the input sequence and the output sequence may represent an image or video, and both the input tokens and the output tokens may represent a respective image or video. In such implementations the method/system may be configured to perform an image or video transformation. For example the input sequence and the output sequence may represent the same image or video in different styles e.g. one as an image the other as a sketch of the image; or different styles for the same item of clothing.

In some implementations the input sequence represents data to be compressed, e.g. image data, text data, audio data, or any other type of data; and the output sequence a compressed version of the data. The input and output tokens may each comprise any representation of the data to be compressed/compressed data e.g. symbols or embeddings generated/decoded by a respective neural network.

In some implementations the input sequence represents a sequence of actions to be performed by an agent e.g. a mechanical agent in a real-world environment implementing the actions to perform a mechanical task. The output sequence may comprise a modified sequence of actions e.g. one in which an operating parameter, such as a speed of motion or power consumption, has a limited value; or one in which or safety or other boundary is less likely to be crossed. Then both the input tokens and the output tokens may represent the actions to be performed.

In some implementations the input sequence represents a sequence of health data and the output sequence may comprise a sequence of predicted treatment. Then the input tokens may represent any aspect of the health of a patient e.g. data from blood and other medical tests on the patient and/or EHR (Electronic Health Record) data; and the output tokens may represent diagnostic information e.g. relating to a disease status of the patient and/or relating to suggested treatments for the patient, and/or relating to a likelihood of an adverse health event for the patient.

In some implementations the input sequence represents a time series and the output sequence may comprise a continuation of the time series. For example the input sequence may be a sequence representing the output of an electricity generating plant, e.g. a solar or wind electricity generating plant, or a sequence representing electricity consumption, and the output sequence may provide a forecast of the electricity generated or consumed. As another example the input sequence may be a sequence representing a level of traffic on one or more roads and the output sequence may provide a forecast of the future traffic.

In some implementations, each network input in the input sequence may comprise a data element embedding. As used herein an embedding refers to an ordered collection of numerical values, e.g., a vector, matrix, or other tensor of numerical values. An embedding of an entity can be generated, e.g., as the output of a neural network that processes data characterizing the entity, or as a result of some other encoding process.”

For example the data element embeddings may represent the pixels of an image and the network output may comprise a classification output, e.g. that includes a respective score for each object category in a set of possible object categories, defining a likelihood that the image depicts an object that belongs to the object category.

In some implementations the data element embeddings represent audio samples in an audio waveform and the system is configured to perform speech recognition, i.e., to generate a network output that defines a sequence of phonemes, graphemes, characters, or words corresponding to the audio waveform.

In some implementations, the data element embeddings represent words in a sequence of words and the system is configured to perform a natural language processing task, e.g., topic classification or summarization. To perform topic classification, the network output can include a respective score for each topic category in a set of possible category categories, e.g. the score for a topic category can define a likelihood that the sequence of words pertains to the topic category.

In some implementations, the system/method is configured to perform an audio processing task. For example, if the data element embeddings represent a spoken utterance, then the network output may be a score for each of a set of pieces of text, each score representing an estimated likelihood that the piece of text is the correct transcript for the utterance. As another example, if the data element embeddings represent a spoken utterance, the network output can indicate whether a particular word or phrase (“hotword”) was spoken in the utterance. As another example, if the data element embeddings represent a spoken utterance, the network output can identify the natural language in which the utterance was spoken.

In some implementations, the system/method can perform an image generation task, where the data element embeddings represent a conditioning input, e.g. text, and the network output defines a sequence of intensity value inputs for the pixels of an image.

In some implementations, as described further below, the system/method can perform an agent control task, where the data element embeddings represent a sequence of one or more observations and/or other data characterizing states of an environment and the network output comprises a policy output as previously described. The agent can be, e.g., a real-world or simulated mechanical agent (such as a robot or vehicle), a control system for an industrial facility, or a control system that controls a different kind of agent.

In some implementations, the system/method can perform a point cloud processing task, e.g., where the data element embeddings represent a point cloud (e.g., generated by a lidar or radar sensor) and the network output characterizes, e.g., a type of object represented by the point cloud.

In some implementations, the system/method is configured to perform a combination of multiple individual machine learning tasks, e.g., two or more of the machine learning tasks mentioned above.

The system/method neural network can process data element embeddings that represent any appropriate type of entity. For example, the entity can include an image, an audio waveform, a point cloud (e.g., generated by a lidar or radar sensor), a protein, a sequence of words (e.g., that form one or more sentences or paragraphs), a video (e.g., represented a sequence of video frames), or a combination thereof, e.g. multimodal data. The network output can characterize the entity or performs a processing task on the entity.

Implementations of the system/method can process multimodal data of a multimodal entity. Such an entity can include may comprise a combination of different types of data, such as image or video data and audio data, image or video data and language data, somatosensory input data (sensor data sensing the real-world environment of a physical agent, such as sensing touch, pressure, movement, temperature or vibration data) and motor feedback data (i.e. control data to control movement of the physical agent). When a multimodal entity is processed by the system/method embeddings of the data elements of the different modalities may be combined.

The network output for the multimodal entity may be as previously described. For example where the network output is a classification output for a classification task (e.g. defining a score for each category of a set of possible categories), this may be as previously described except that the network output is generated based upon the multimodal data embeddings provided as the input. Thus the machine learning task, e.g. classification, performed by the system may be performed better, e.g. more accurately, as a result. For example a classification task may be performed on a combination of video and (corresponding) audio data to obtain a more accurate classification result. As another example the machine learning task may be one that is based upon processing data of different modalities, e.g. in a task that combines video or image data and language data e.g. text data, to determine whether an image or video is described by a particular caption.

### Agent Control

In some implementations the system/method is part of a reinforcement learning system. The reinforcement learning system is an example of a system implemented as computer programs on one or more computers in one or more locations in which the systems, components, and techniques described are implemented.

The reinforcement learning system selects actions to be performed by an agent interacting with an environment at each of multiple successive time steps. At each time step, the system receives data characterizing the current state of the environment, e.g., an image of the environment, and selects an action to be performed by the agent in response to the received data. Data characterizing a state of the environment is referred herein as an observation.

In general an observation may also include a goal, e.g. an embedding of a goal, for the agent and/or data characterizing the task or environment, e.g. the “production rules” as described later.

Once the reinforcement learning system selects an action to be performed by the agent, the reinforcement learning system can cause the agent to perform the selected action. For example, the system can instruct the agent and the agent can perform the selected action. As another example, the system can directly generate control signals for one or more controllable elements of the agent. As yet another example, the system can transmit data specifying the selected action to a control system of the agent, which controls the agent to perform the action. Generally, the agent performing the selected action results in the environment transitioning into a different state.

The techniques described herein is widely applicable and is not limited to one specific implementation. However, for illustrative purposes, a small number of example implementations are described below.

In some implementations, the environment is a real-world environment, the agent is a mechanical (or electro-mechanical) agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example captured by a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent 10 may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

In general for the systems described herein, in response to some or all of the actions performed by the agent, the reinforcement learning system can receive a reward. Each reward is a numeric value received from the environment as a consequence of the agent performing an action, i.e., the reward will be different depending on the state that the environment transitions into as a result of the agent performing the action. The rewards may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control usage of a resource, the metric may comprise any metric of the usage of the resource. In the case of a task which is to control an electromechanical agent such as a robot to perform a manipulation of an object, the reward may indicate whether the object has been correctly manipulated according to a predefined criterion.

In general, observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case that the agent is a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor (e.g. mounted on the machine). Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment, such as a heater, a cooler, a humidifier, or other hardware that modifies a property of air in the real-world environment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment.

In general the actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general, the observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards may relate to a metric of performance of a task relating to the efficient operation of the facility. For example in the case of a task to control, e.g. minimize, use of a resource, such as a task to control use of electrical power or water, the metric may comprise any metric of use of the resource.

In some implementations the environment is the real-world environment of a power generation facility, e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The rewards may relate to a metric of performance of a task relating to power distribution. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such observations may thus include observations of wind levels or solar irradiance, or of local time, date, or season. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that indirectly performs or controls the protein folding actions, or chemical synthesis steps, e.g. by controlling synthesis steps selected by the system automatically without human interaction. The observations may comprise direct or indirect observations of a state of the protein or chemical/intermediates/precursors and/or may be derived from simulation. Thus the system may be used to automatically synthesize a protein with a particular function such as having a binding site shape, e.g. a ligand that binds with sufficient affinity for a biological effect that it can be used as a drug. For example e.g. it may be an agonist or antagonist of a receptor or enzyme; or it may be an antibody configured to bind to an antibody target such as a virus coat protein, or a protein expressed on a cancer cell, e.g. to act as an agonist for a particular receptor or to prevent binding of another ligand and hence prevent activation of a relevant biological pathway.

In a similar way the environment may be a drug design environment such that each state is a respective state of a potential pharmaceutically active compound pharmaceutically active compound and the agent is a computer system for determining elements of the pharmaceutically active compound and/or a synthetic pathway for the pharmaceutically active compound. The drug/synthesis may be designed based on a reward derived from a target for the pharmaceutically active compound, for example in simulation. As another example, the agent may be a mechanical agent that performs or controls synthesis of the pharmaceutically active compound.

In some further applications, the environment is a real-world environment and the agent manages distribution of tasks across computing resources e.g. on a mobile device and/or in a data center. In these implementations, the actions may include assigning tasks to particular computing resources. In these applications, the observations may include observations of computing resources such as compute and/or memory capacity, or Internet-accessible resources; and the actions may include assigning tasks to particular computing resources. The reward(s) may be configured to maximize or minimize one or more of: utilization of computing resources, electrical power, bandwidth, and computation speed.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The rewards may comprise one or more metrics of performance of the design of the entity. For example rewards may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus a design of an entity may be optimized, e.g. by reinforcement learning, and then the optimized design output for manufacturing the entity, e.g. as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, the action selection policy may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to recreate in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In some implementations, as described above, the agent may not include a human being (e.g. it is a robot). Conversely, in some implementations the agent comprises a human user of a digital assistant such as a smart speaker, smart display, or other device. Then the information defining the task can be obtained from the digital assistant, and the digital assistant can be used to instruct the user based on the task.

For example, the reinforcement learning system may output to the human user, via the digital assistant, instructions for actions for the user to perform at each of a plurality of time steps. The instructions may for example be generated in the form of natural language (transmitted as sound and/or text on a screen) based on actions chosen by the reinforcement learning system. The reinforcement learning system chooses the actions such that they contribute to performing a task. A monitoring system (e.g. a video camera system) may be provided for monitoring the action (if any) which the user actually performs at each time step, in case (e.g. due to human error) it is different from the action which the reinforcement learning system instructed the user to perform. Using the monitoring system the reinforcement learning system can determine whether the task has been completed. The reinforcement learning system may identify actions which the user performs incorrectly with more than a certain probability. If so, when the reinforcement learning system instructs the user to perform such an identified action, the reinforcement learning system may warn the user to be careful. Alternatively or additionally, the reinforcement learning system may learn not to instruct the user to perform the identified actions, i.e. ones which the user is likely to perform incorrectly.

More generally, the digital assistant instructing the user may comprise receiving, at the digital assistant, a request from the user for assistance and determining, in response to the request, a series of tasks for the user to perform, e.g. steps or sub-tasks of an overall task. Then for one or more tasks of the series of tasks, e.g. for each task, e.g. until a final task of the series the digital assistant can be used to output to the user an indication of the task, e.g. step or sub-task, to be performed. This may be done using natural language, e.g. on a display and/or using a speech synthesis subsystem of the digital assistant. Visual, e.g. video, and/or audio observations of the user performing the task may be captured, e.g. using the digital assistant. A system as described above may then be used to determine whether the user has successfully achieved the task e.g. step or sub-task, i.e. from the answer as previously described. If there are further tasks to be completed the digital assistant may then, in response, progress to the next task (if any) of the series of tasks, e.g. by outputting an indication of the next task to be performed. In this way the user may be led step-by-step through a series of tasks to perform an overall task. During the training of the neural network, training rewards may be generated e.g. from video data representing examples of the overall task (if corpuses of such data are available) or from a simulation of the overall task.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g. a conversation agent such as Sparrow or Chinchilla. The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks e.g. of a series of tasks, e.g. until a final task of the series. More particularly the assistance control subsystem and output to the user an indication of the task to be performed, capture, using the observation capture subsystem, visual or audio observations of the user performing the task, determine from the above-described answer whether the user has successfully achieved the task. In response the digital assistant can progress to a next task of the series of tasks and/or control the digital assistant, e.g. to stop capturing observations.

In some implementations, the environment may not include a human being or animal. In other implementations, however, it may comprise a human being or animal. For example, the agent may be an autonomous vehicle in an environment which is a location (e.g. a geographical location) where there are human beings (e.g. pedestrians or drivers/passengers of other vehicles) and/or animals, and the autonomous vehicle itself may optionally contain human beings. The environment may also be at least one room (e.g. in a habitation) containing one or more people. The human being or animal may be an element of the environment which is involved in the task, e.g. modified by the task (indeed, the environment may substantially consist of the human being or animal). For example the environment may be a medical or veterinary environment containing at least one human or animal subject, and the task may relate to performing a medical (e.g. surgical) procedure on the subject. In a further implementation, the environment may comprise a human user who interacts with an agent which is in the form of an item of user equipment, e.g. a digital assistant. The item of user equipment provides a user interface between the user and a computer system (the same computer system(s) which implement the reinforcement learning system, or a different computer system). The user interface may allow the user to enter data into and/or receive data from the computer system, and the agent is controlled by the action selection policy to perform an information transfer task in relation to the user, such as providing information about a topic to the user and/or allowing the user to specify a component of a task which the computer system is to perform. For example, the information transfer task may be to teach the user a skill, such as how to speak a language or how to navigate around a geographical location; or the task may be to allow the user to define a three-dimensional shape to the computer system, e.g. so that the computer system can control an additive manufacturing (3D printing) system to produce an object having the shape. Actions may comprise outputting information to the user (e.g. in a certain format, at a certain rate, etc.) and/or configuring the interface to receive input from the user. For example, an action may comprise setting a problem for a user to perform relating to the skill (e.g. asking the user to choose between multiple options for correct usage of the language, or asking the user to speak a passage of the language out loud), and/or receiving input from the user (e.g. registering selection of one of the options, or using a microphone to record the spoken passage of the language). Rewards may be generated based upon a measure of how well the task is performed. For example, this may be done by measuring how well the user learns the topic, e.g. performs instances of the skill (e.g. as measured by an automatic skill evaluation unit of the computer system). In this way, a personalized teaching system may be provided, tailored to the aptitudes and current knowledge of the user. In another example, when the information transfer task is to specify a component of a task which the computer system is to perform, the action may comprise presenting a (visual, haptic or audio) user interface to the user which permits the user to specify an element of the component of the task, and receiving user input using the user interface. The rewards may be generated based on a measure of how well and/or easily the user can specify the component of the task for the computer system to perform, e.g. how fully or well the three-dimensional object is specified. This may be determined automatically, or a reward may be specified by the user, e.g. a subjective measure of the user experience. In this way, a personalized system may be provided for the user to control the computer system, again tailored to the aptitudes and current knowledge of the user.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network.

The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method performed by one or more computers, the method comprising:
obtaining an input sequence of network inputs;
processing each network input in the input sequence using a recurrent neural network to generate a sequence of recurrent outputs that includes a respective recurrent output for each network input in the input sequence;
generating a sub-sampled sequence that includes a proper subset of the respective recurrent outputs; and
processing the sub-sampled sequence using a self-attention neural network to generate a network output for the input sequence, wherein the self-attention neural network comprises:
a self-attention subnetwork configured to apply self-attention over the sub-sampled sequence to generate a respective updated output for each recurrent output in the sub-sampled sequence; and
an output neural network configured to process one or more of the updated outputs to generate the network output for the input sequence.

2. The method of claim 1, wherein each network input in the input sequence corresponds to a respective time step and represents an observation characterizing a state of an environment at the corresponding time step, and wherein the network output for the input sequence comprises a policy output that defines an action to be performed by an agent interacting with the environment in response to the observation represented by a last network input in the input sequence.

3. The method of claim 2, wherein the network output further comprises a value output that represents an expected return received starting from the respective time step corresponding to the last network input in the input sequence.

4. The method of claim 2, wherein each network input comprises an embedding of the observation characterizing the state of an environment at the corresponding time step generated by an embedding neural network.

5. The method of claim 2, wherein the output neural network comprises a second recurrent neural network configured to generate policy outputs for time steps between sub-sampled time steps corresponding to the sub-sampled sequence.

6. The method of claim 1, wherein each network input in the input sequence corresponds to a respective time step in an audio signal and represents an audio sample at the corresponding time step in the audio signal.

7. The method of claim 1, wherein each network input in the input sequence represents a respective image in a sequence of images.

8. The method of claim 1, wherein the self-attention subnetwork includes one or more self-attention layer blocks that each apply self-attention to update the sub-sampled sequence.

9. The method of claim 8, wherein at least one of the self-attention layer blocks apply self-attention with segment-level recurrence.

10. The method of claim 8, wherein the self-attention subnetwork is configured to apply normalization to an output of one or more of the self-attention layer blocks.

11. The method of claim 8, wherein each self-attention layer block comprises:
a self-attention layer that applies self-attention to update the sub-sampled sequence; and
a gated feedforward neural network that is configured to further update each output in the updated sub-sampled sequence.

12. The method of claim 1, wherein processing each network input in the input sequence using a recurrent neural network to generate a sequence of recurrent outputs that includes a respective recurrent output for each network input in the input sequence comprises:
prior to processing a first network input in the input sequence, initializing an internal state of the recurrent neural network; and
for each network input in the input sequence, processing the network input using the recurrent neural network in accordance with the internal state to update the internal state and generate the respective recurrent output for the network input.

13. The method of claim 12, wherein the recurrent neural network includes one or more recurrent layers, wherein the internal state includes a respective layer internal state for each of the one or more recurrent layers, and wherein the respective recurrent output for the network input is the updated the layer internal state of a last recurrent layer after processing the network input.

14. The method of claim 1, wherein the recurrent neural network is a gated recurrent unit (GRU).

15. The method of claim 1, wherein generating a sub-sampled sequence that includes a proper subset of the respective recurrent outputs comprises:
selecting for inclusion in the sub-sampled sequence only every k-th recurrent output in the sequence of recurrent outputs, wherein k is an integer that is greater than one.

16. The method of claim 15, wherein k is between 4 and 10, inclusive.

17. The method of claim 1 wherein each network input in the input sequence comprises an embedding of multimodal data.

18. One or more non-transitory computer-readable storage media storing instructions that when executed by one or more computers cause the one or more computers to perform operations comprising:
obtaining an input sequence of network inputs;
processing each network input in the input sequence using a recurrent neural network to generate a sequence of recurrent outputs that includes a respective recurrent output for each network input in the input sequence;
generating a sub-sampled sequence that includes a proper subset of the respective recurrent outputs; and
processing the sub-sampled sequence using a self-attention neural network to generate a network output for the input sequence, wherein the self-attention neural network comprises:
a self-attention subnetwork configured to apply self-attention over the sub-sampled sequence to generate a respective updated output for each recurrent output in the sub-sampled sequence; and
an output neural network configured to process one or more of the updated outputs to generate the network output for the input sequence.

19. A system comprising one or more computers and one or more storage devices storing instructions that when executed by one or more computers cause the one or more computers to perform operations comprising:
obtaining an input sequence of network inputs;
processing each network input in the input sequence using a recurrent neural network to generate a sequence of recurrent outputs that includes a respective recurrent output for each network input in the input sequence;
generating a sub-sampled sequence that includes a proper subset of the respective recurrent outputs; and
processing the sub-sampled sequence using a self-attention neural network to generate a network output for the input sequence, wherein the self-attention neural network comprises:
a self-attention subnetwork configured to apply self-attention over the sub-sampled sequence to generate a respective updated output for each recurrent output in the sub-sampled sequence; and
an output neural network configured to process one or more of the updated outputs to generate the network output for the input sequence.

20. The system of claim 19, wherein each network input in the input sequence corresponds to a respective time step and represents an observation characterizing a state of an environment at the corresponding time step, and wherein the network output for the input sequence comprises a policy output that defines an action to be performed by an agent interacting with the environment in response to the observation represented by a last network input in the input sequence.
